(19) United States
(12) Patent Application Publication
(10) Pub. No.: US 2009/0213458 A1
(43) Pub. Date: Aug. 27, 2009

(54) FLOOR MOUNTED REAR PROJECTION SCREEN STRUCTURE AND DISPLAY SYSTEM

(76) Inventor: Grant W. STEWART, Cincinnati, OH (US)

Correspondence Address: HASSE & NESBITT LLC, 8837 CHAPEL SQUARE DRIVE, SUITE C, CINCINNATI, OH, 45249, US

(21) Appl. No.: 12/038,271

(22) Filed: Feb. 27, 2008

(51) Int. Cl. G03B 21/56

(52) U.S. Cl. 359/460

(57) ABSTRACT

A floor mounted rear projection screen structure and display system is provided that includes a rear projection screen disposed in an opening defined in the floor and a projection system for projecting images onto the projection screen from beneath the screen.

### TECHNICAL FIELD

This invention relates generally to floor display systems, and more particularly to a floor mounted rear projection screen and projection system for projecting images from beneath the floor for display on the projection screen.

### BACKGROUND OF THE INVENTION

Rear projection screens, in which modulated light from a projector is illuminated on the side facing away from the viewer and that light is viewed on the side facing the viewer, find wide use for displaying visual content or imagery accompanying oral presentations, slide shows, movies, television shows, and the like.

U.S. Pat. No. 6,839,167, Eckelt, et al., describes a projection screen formed by assembling two glass plates with a layer of white translucent polyvinyl butyral (PVB) therebetween. U.S. Pat. No. 7,253,953, Browning, describes a projection screen having two glass plates with a polymer layer disposed therebetween comprising polyorgano silsesquioxane microspheres that enhance light diffusing properties of the screen. In Browning, the projection screen is formed by first extruding the polymer layer, and then sandwiching the polymer layer between two glass plates. The entire contents of the Browning patent are incorporated by reference herein.

Floor mounted visual display structures have generally included electronic display devices such as described in U.S. Pat. Nos. 6,982,649 and 7,009,523 to Blum et al. These structures are often constructed of a plurality of display modules, each consisting of an electronic display device. A need exists for a floor mounted rear projection screen structure with projection system for displaying visual content to an observer standing or walking on the floor structure.

### SUMMARY OF THE INVENTION

The invention provides a floor mounted rear projection screen and associated projection system for projecting images onto the projection screen from beneath the floor.

The invention therefore relates to a floor mounted rear projection screen structure, comprising, a floor structure having an opening defined therein and a rear projection screen disposed within said opening, said rear projection screen having a top surface and a bottom surface and having at least two layers of glass and a polymer layer disposed between said layers of glass, said screen configured for displaying at said top surface visual content projected onto a bottom surface of said screen.

A further embodiment includes projector means for projecting visual content onto the rear projection screen at the bottom surface thereof.

The invention also relates to an improved floor mounted display system including a floor structure having a top surface defining a walkway, including, an opening defined in the floor structure at the top surface, a rear projection screen disposed within said opening, said rear projection screen having a top surface and a bottom surface and having at least two layers of glass and a polymer layer disposed between said layers of glass, said screen configured for displaying at said top surface visual content projected onto said bottom surface of said screen, and projector means for projecting visual content onto said rear projection screen at said bottom surface thereof.

The invention also relates to an improved floor structure having a top surface defining a walkway, the improvement comprising an opening defined in said floor structure, a rear projection screen disposed within said opening, said rear projection screen having a top surface and a bottom surface and configured for displaying at said top surface visual content projected onto said bottom surface, and further comprising means for projecting visual content onto said rear projection screen at said bottom surface thereof.

The invention contemplates the use of projector means located either immediately beneath the floor near the location where the projection screen is mounted, or remote of the projection screen, for projecting visual content onto the projection screen and may include any of the projector means known in the art, including a television projector, motion picture projector, slide projector, video projector and computer generated images display system.

One aspect of the invention resides in a floor mounted rear projection screen for displaying images to persons walking on the floor.

In another aspect of the invention, the projection screen may comprise a portion of the walking surface of the floor in which the screen is mounted.

In other aspects of the invention, the projection screen can be co-planer with the floor surface, recessed into the floor, or raised above the floor surface.

Another aspect of the invention resides in the applicability of the invention to any floor structure in which a projection screen is mounted, whereby images from a projection source may be viewed as projected from beneath the projection screen.

A significant advantage of the invention is that the screen structure which comprises the invention can be sized substantially larger than prior art systems comprising electronic display devices.

Other aspects, advantages and objects of the invention will become apparent as a detailed description of representative embodiments of the invention proceeds.

### BRIEF DESCRIPTION OF THE DRAWINGS

The invention will be more clearly understood from the following detailed description of representative embodiments thereof read in conjunction with the accompanying drawings that form a part of this disclosure.

FIG. 1 is a perspective view in partial cutaway of a floor structure having a rear projection screen mounted therein with a projection system for projecting visual content onto the rear projection screen according to the invention.

FIG. 2 is a sectional view along lines 2-2 of the FIG. 1 floor mounted projection screen structure illustrating an alternative structure for the projection screen of the invention.

### DETAILED DESCRIPTION OF THE INVENTION

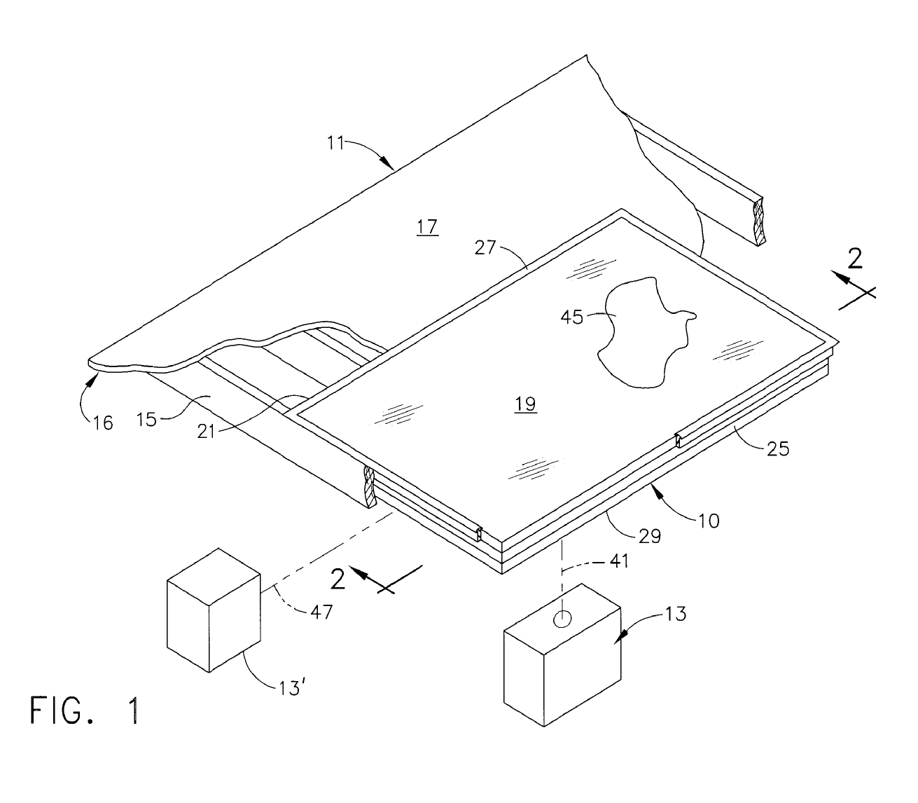

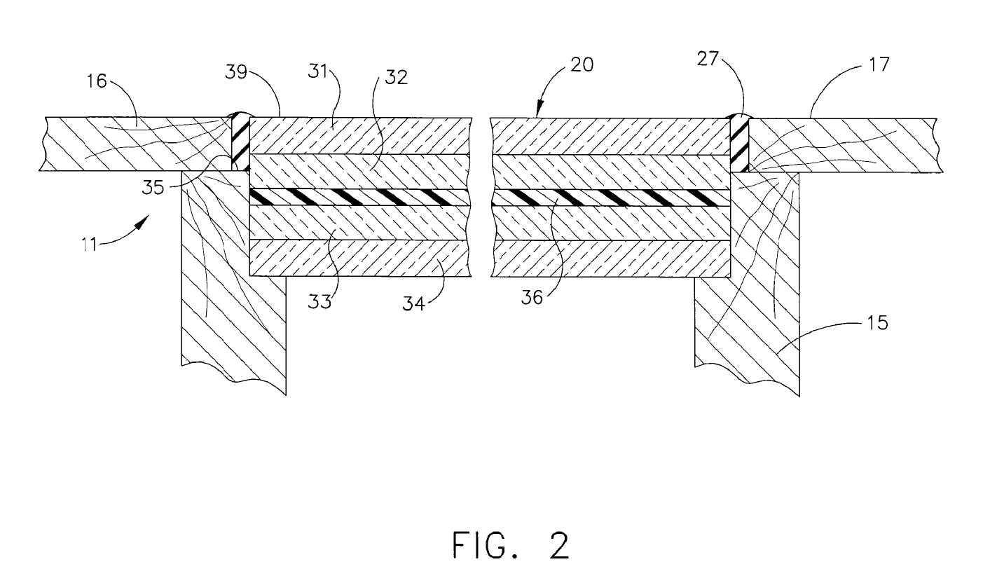

Referring now to the drawings, FIG. 1 is a perspective view in partial cutaway of a rear projection screen structure 10 mounted into the floor 11 of a building or the like, and showing a projection system 13 for projecting visual content onto the rear (bottom) of the projection screen structure 10, according to the invention. FIG. 2 is a view in section of a portion of the FIG. 1 floor structure 11 as taken along lines 2-2 illustrating a projection screen structure useful in the invention. It should be noted at the outset that the floor structure 11 illustrated in FIG. 1 is shown as a conventional structure including floor joists 15 of wood, metal or other material typically used in the construction industry with flooring 16 of any conventional material also used in the construction industry, such as wood board, paneling or laminates, tile and cement sheeting, or other material, the same not considered limiting of the teachings of this invention or of the appended claims. The structure represented in the drawings as floor structure 11 is only representative of the floor structures into which a rear projection screen 10 and associated projection system 13 according to the invention can be incorporated. Other floor structures, such as comprising reinforced concrete (not shown) may also be used as the flooring material in which the screen and projection system of the invention can be disposed.

In accordance with one aspect of the invention, rear projection screen structure 10 is incorporated into floor structure 11 at the generally horizontal top surface 17 defining a walkway for floor structure 11. Screen structure 10 is configured for displaying images in the form of a television display, movie, computer generated display, slide show or other visual display for presentation to persons standing, walking or the like, on top of floor structure 11. Screen 10 may be disposed within top surface 17 of floor structure 11 in manner such that the top surface 19 of screen 10 is substantially co-planar with floor surface 17, or, in some applications, it may be desirable to recess screen 10 into floor structure 11 so that the top surface 19 of screen 10 lies below the level of floor surface 17, or, alternatively, to mount screen 10 in a raised condition rendering top surface 19 somewhat above the level of surface 17. In one embodiment of the invention, screen 10 is sized to fit between and supported on floor structure 11 such as suggested in the cross section view shown in FIG. 2.

The structure of screen 10 may comprise substantially any composition or number of layers or combination materials customarily used in rear projection screen structures including glass, polymers, plastics or others as would occur to the skilled artisan guided by these teachings, requiring only that the overall structure of screen 10 be strong enough, as with the remainder of floor structure 11, to support persons walking or standing thereon. Representative structures for screen 10 include two or more layers 25 of plate glass of suitable thickness to provide the required strength (such as about 0.5 inch thick or more for each layer) for supporting the weight of persons walking thereon. Screen 10 may be held in any suitable fashion within an opening 21 in top surface 15, such as by a flanged arrangement 35 on the inside edge of opening 21, and scaled around the periphery of screen structure 10 using conventional sealing materials, gaskets, finish trim or the like as suggested at 27 in order to provide a top surface 19 of screen structure 10 that is substantially continuous with top surface 17 of floor structure 11. One or more of the upper or lower surfaces 19 or 29 of the constituent glass layers 25 can have a smoked or frosted (etched) surface in order to provide a projection surface required to display images in accordance with the invention, all as hereinafter more fully described. More than one such screen structures 10 may be incorporated into floor structure 11 to provide enhanced display effects.

The sectional view of FIG. 2 illustrates a projection screen 20 according to the invention which may comprise a layered structure of at least two glass plates each of about 0.5 inch or more thickness (greater thickness may be desirable for enhanced strength in a particular application) with a polymer layer 36 (such as translucent polyvinyl butyral about 0.015 inch thick) disposed between two of the glass plates. In one embodiment 20 as illustrated in FIG. 2, the screen structure included four (4) one-half inch thick glass layers 31-34 (preferably of low iron content). The overall thickness of screen structure 20 may therefore be about 2.5 inches or more depending on the required structural strength for a given application. Screen 20 can range in size up to about four (4) feet in width and up to about seven (7) feet in length. One non-limiting example structure for screen 10 or 20 includes the projection screen material STARGLAS (Stewart Filmscreen Corporation) suitable for use simultaneously as a rear projection screen for the desired visual display and as a walk about area. Upper surface 19 of screen structure 10 or upper surface 39 of screen structure 20 may have surface roughness as by frosting or etching and conventional antireflection coatings to prevent unwanted reflections. Glass composition and additives may be selected by one skilled in the applicable art in practicing the invention as taught herein. Polymer layers useful in the structure of screen 11 may otherwise include any of those described in U.S. Pat. No. 7,253,953 to Browning, and in U.S. Pat. No. 6,825,255 to Yuan et al., the entire teachings of both being incorporated herein by reference, such as polyvinyl butyral, polyurethane, polyvinyl chloride, or poly (ethylene vinyl acetate), or combinations thereof.

It is noted that an additional protective layer (not shown) of clear plastic, glass or other clear transparent material may be applied over the screen structure in order to preclude scratching or other surface damage to the exposed upper surface of the screen structure (10 or 20). This may be particularly desirable for floor structures according to the invention wherein screen structure 10 is recessed into floor 11 so that upper surface 19 of screen structure 10 lies at a level below the level of floor surface 17.

With reference again to FIG. 1, and in accordance with another aspect of the invention, a source of a visual display in the form of projector means 13 may be disposed beneath floor structure 11 and screen structure 10 (or 20) in order to project images onto projection screen 10 from beneath top surface 19, for display to the walk about area of floor structure 11. Imagery projection by projection means 13 can be accomplished using suitable conventional optical projection means 41 selected by one skilled in the applicable art practicing this invention, for displaying the visual content of images 45 at surface 19.

The projection system 13 that provides the projected images within the intended scope of the invention and of the appended claims may comprise any conventional projection means including television projector, motion picture or slide projector, or video projector, or a computer generated images display system, or the like, disposed beneath screen structure 10. Alternatively, the projection system 13′ may be disposed remote of screen structure 10 with optical means 47 (such as by use of conventional fiber optics devices illustrated by the broken line in FIG. 1) to conduct the imagery from such remotely disposed projection source 13′ for display on screen 10 as described above.

The invention therefore provides a floor mounted rear projection screen structure and display system including a rear projection screen, and a projection system for displaying images on the screen from beneath the floor. It is understood that modifications to the invention may be made as might occur to one with skill in the field of the invention within the scope of the appended claims. All embodiments contemplated hereunder that achieve the benefits of the invention have therefore not been shown in complete detail. Other embodiments may be developed without departing from the spirit of the invention or from the scope of the appended claims.

What is claimed is:

1. A floor mounted rear projection screen structure, comprising:
(a) a floor structure having an opening defined therein; and
(b) a rear projection screen disposed within said opening, said rear projection screen having a top surface and a bottom surface and having at least two layers of glass and a polymer layer disposed between said layers of glass, said screen configured for displaying at said top surface visual content projected onto said bottom surface of said screen.

2. The structure of claim 1 further comprising projector means for projecting visual content onto said rear projection screen at said bottom surface thereof

3. The structure of claim 2 wherein said projector means is disposed remote of said rear projection screen, and comprising optical means for transmitting said visual content from said projector means onto said bottom surface of said screen.

4. The structure of claim 1 wherein said top surface of said rear projection screen is substantially co-planar with said top surface of said floor structure.

5. The structure of claim 1 wherein said polymer layer comprises a polymer selected from the group consisting polyvinyl butyral, polyurethane, polyvinyl chloride, and poly (ethylene vinyl acetate).

6. The structure of claim 1 where said rear projection screen comprises at least four layers of glass with a polymer layer disposed between two of said layers of glass.

7. The structure of claim 6 wherein said polymer layer comprises a polymer selected from the group consisting polyvinyl butyral, polyurethane, polyvinyl chloride, and poly (ethylene vinyl acetate).

8. The structure of claim 1 wherein said projector means is selected from the group consisting of a television projector, motion picture projector, slide projector, video projector, and computer generated images display system.

9. In a floor structure having a top surface defining a walkway, an improvement, comprising;
(a) an opening defined in said floor structure at said top surface;
(b) a rear projection screen disposed within said opening, said rear projection screen having a top surface and a bottom surface and having at least two layers of glass and a polymer layer disposed between said layers of glass, said screen configured for displaying at said top surface visual content projected onto said bottom surface of said screen; and
(c) projector means for projecting visual content onto said rear projection screen at said bottom surface thereof.

10. The structure of claim 9 wherein said projector means is disposed remote of said rear projection screen, and comprising optical means for transmitting said visual content from said projector means onto said bottom surface of said rear projection screen.

11. The improvement of claim 9 wherein said top surface of said rear projection screen is substantially coplanar with said top surface of said structure.

12. The improvement of claim 1 wherein said polymer layer comprises a polymer selected from the group consisting polyvinyl butyral, polyurethane, polyvinyl chloride, and poly (ethylene vinyl acetate).

13. The improvement of claim 9 where said rear projection screen comprises at least four layers of glass with a polymer layer disposed between two of said layers of glass.

14. The improvement of claim 13 wherein said polymer layer comprises a polymer selected from the group consisting polyvinyl butyral, polyurethane, polyvinyl chloride, and poly (ethylene vinyl acetate).

15. The improvement of claim 9 wherein said projector means is selected from the group consisting of a television projector, motion picture projector, slide projector, video projector, and computer generated images display system.

16. In a floor structure having a top surface defining a walkway, an improvement comprising, an opening defined in said floor structure, a rear projection screen disposed within said opening, said rear projection screen having a top surface and a bottom surface and configured for displaying at said top surface visual content projected onto said bottom surface, and further comprising means for projecting visual content onto said rear projection screen at said bottom surface thereof.

17. The improvement of claim 16 wherein said means for projecting visual content onto said rear projection screen is disposed remote of said rear projection screen.

18. The improvement of claim 16 wherein said rear projection screen comprises at least two layers of glass.

19. The improvement of claim 18 where said rear projection screen comprises at least four layers of glass with a polymer layer disposed between two of said layers of glass.

20. The improvement of claim 16 wherein said means for projecting visual content onto said rear projection screen includes projector means selected from the group consisting of a television projector, motion picture projector, slide projector, video projector, and computer generated images display system.
